(19) United States
(12) Patent Application Publication
(10) Pub. No.: US 2009/0040786 A1
(43) Pub. Date: Feb. 12, 2009

(54) SURFACE LIGHT SOURCE APPARATUS AND DISPLAY APPARATUS

(75) Inventor: Akihiro Mori, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/184,527

(22) Filed: Aug. 1, 2008

(30) Foreign Application Priority Data
Aug. 10, 2007 (JP) 2007-208909

(51) Int. Cl. F21V 7/04

(52) U.S. Cl. 362/616

(57) ABSTRACT

An object is to provide a surface light source apparatus excellent in uniformity of brightness and chromaticity without being affected by variations in performance between point light sources, or a display apparatus using the surface light source apparatus. A surface light source apparatus according to the present invention includes a plurality of point light sources, a first light guide body that propagates light received from the plurality of point light sources and emits the same from an outgoing surface, and a second light guide body that receives the light emitted from the outgoing surface of the first light guide body at an incident surface to propagate, and emits the same from an outgoing surface substantially perpendicular to the incident surface, wherein at least some of the plurality of point light sources are arrayed in a direction substantially perpendicular to the outgoing surface of the first light guide body.

### BACKGROUND OF THE INVENTION

1. Field of the Invention

The present invention relates to a surface light source apparatus and a display apparatus including the surface light source apparatus.

2. Description of the Background Art

In a surface light source apparatus using conventional point light sources, a plurality of point light sources are generally arranged parallel to an incident surface in the vicinity of the incident surface of a light guide body that propagates light. Alternatively, there has been proposed a technique in which a plurality of point light sources are arranged parallel to an incident surface of an auxiliary light guide plate for improving uniformity of light from the point light sources, and the light emitted from the auxiliary light guide plate is turned back by a reflector so as to again enter a light guide body made of a transparent material or a hollow light guide body.

In the above-described surface light source apparatus using point light sources, point light sources such as light emitting diodes (hereinafter, referred to as LEDs) are generally used, and there may be a case where as the LEDs, ones emitting white light, or a plurality of point light sources different in color such as red, green and blue are arrayed. There is generally used a technique in which the light emitted from the point light sources is propagated inside the light guide body, and diffused in a diffusing pattern provided in the light guide body to thereby be taken out from an outgoing surface.

In the above-described surface light source apparatus using the LEDs as the point light sources, the use of the plurality of point light sources has posed a problem that variations in brightness and chromaticity between the respective point light sources deteriorate the uniformity of the brightness and chromaticity in the outgoing surface of the light or a display surface of a display apparatus. Moreover, especially when the LEDs of different colors such as red, green and blue (hereinafter, referred to as RGB) are used in the one surface light source apparatus, there has been a problem that since properties of the LEDs are different, chromaticity uniformity in the outgoing surface deteriorates due to differences in brightness fluctuation attributed to a temperature condition when they are used between the respective colors of RGB, and differences in brightness decreasing rate in long-term use attributed to differences in lifetime property.

Consequently, there have been proposed a structure in which the light from the point light sources are caused to temporarily enter a light guide body and is propagated so as to be uniform, and again caused to enter a light guide body provided separately and is emitted to a display surface, and a technique in which by detecting brightness for each color in the point light sources of RGB to adjust output, the brightness of elements of the respective colors are kept constant or the like.

As related art documents on surface light sources, Japanese Patent Application Laid-Open No. 2004-171947 and Japanese Patent Application Laid-Open No. 2006-351522 are cited.

However, in any of the above-described cases, especially in the surface light source apparatus using the plurality of point light sources and requiring high uniformity, there has been a problem that it is difficult to completely eliminate influence by the variations between the point light sources, so that sufficient performance cannot be ensured.

### SUMMARY OF THE INVENTION

An object is to provide a surface light source apparatus excellent in uniformity of brightness and chromaticity without being affected by variations in performance between point light sources, or a display apparatus using the surface light source apparatus.

A surface light source apparatus includes a plurality of point light sources, a first light guide means, and a second light guide means.

The first light guide means propagates light received from the plurality of point light sources and emits the same from an outgoing surface.

The second light guide means receives the light emitted from the outgoing surface of the first light guide means at an incident surface to propagate, and emits the same from an outgoing surface substantially perpendicular to the incident surface.

The plurality of point light sources are arrayed in a direction substantially perpendicular to the outgoing surface of the first light guide means, and arrayed substantially in the center with respect to the outgoing surface.

In the surface light source apparatus of the present invention, even in a case where the point light sources that emit emission colors different in property such as RGB are used, unbiased incident light from the respective point light sources can be obtained in the incident surface to the second light guide means, so that with the light emission in the second light guide means, favorable uniformity in brightness and chromaticity can be obtained.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a surface light source apparatus in a first embodiment of the present invention;

FIG. 2 is a cross-sectional view of the surface light source apparatus in the first embodiment of the present invention;

FIG. 3 is a view showing arrangement of point light sources in the first embodiment of the present invention;

FIGS. 4 and 5 are views showing arrangement of point light sources in second embodiment of the present invention; and

FIG. 6 is a cross-sectional view of a surface light source apparatus in a third embodiment of the present invention.

### DESCRIPTION OF THE PREFERRED EMBODIMENTS

Hereinafter, this invention is specifically described based on the drawings showing embodiments.

### First Embodiment

### (Constitution)

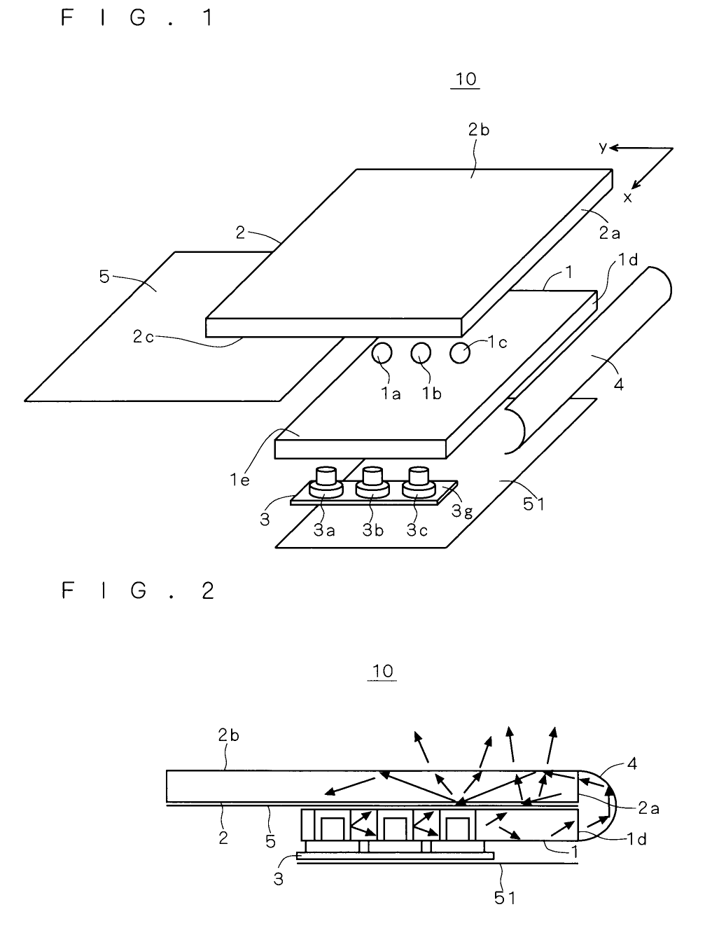

FIG. 1 is an exploded perspective view of a surface light source apparatus according to the present embodiment, and FIG. 2 is a cross-sectional view after assembling.

As shown in FIG. 1, a surface light source apparatus 10 according to the present embodiment has a first light guide body (first light guide means) 1 including depressions or holes 1a to 1c in which a plurality of point light sources 3a to 3c are contained, and an outgoing surface 1d from which light is emitted. Moreover, the surface light source apparatus 10 has a second light guide body (second light guide means) 2 that receives the light emitted from the first light guide body at an incident surface 2a to propagate, and emits the same from an outgoing surface 2b substantially perpendicular to the incident surface 2a. Furthermore, the surface light source apparatus 10 has a reflecting sheet 5 for shielding light between the first light guide body and the second light guide body, a light source apparatus 3 in which the plurality of point light sources 3a to 3c are mounted on a substrate 3g, and a reflector 4 that deflects the light emitted from the first light guide body and causes the same to enter the second light guide body 2.

The first light guide body 1 propagates the light received from the plurality of point light sources 3a to 3c to emit the same from the outgoing surface 1d. The depressions or holes 1a to 1c are provided substantially in the vicinity of the center with respect to an x direction of the first light guide body 1 as shown in FIG. 1, and are arrayed in a direction substantially perpendicular to the outgoing surface 1d to be formed. The first light guide body 1 is made of a transparent resin material of PMMA or polycarbonate, or a transparent material of glass or the like, and respective composing surfaces are smooth optical surfaces that do not cause diffusion of light.

In the present embodiment, the second light guide body 2 is also made of a transparent material similar to the first light guide body 1. in the outgoing surface 2b or a back surface 2c of the second light guide body 2, diffusion means by a fine pattern shape, printing or the like is provided, although being not shown. As shown in FIG. 2, the first light guide body 1 and the second light body 2 are vertically superimposed while sandwiching the reflecting sheet 5 for shielding the light between an upper surface 1e of the first light guide body 1 and the back surface 2c of the second light guide body 2.

The light source apparatus 3 is formed by mounting the plurality of point light sources 3a to 3c on the light source substrate 3g, as shown in FIG. 1, and the plurality of point light sources 3a to 3c are placed so as to be contained in the depressions or holes 1a to 1c formed in the first light guide body 1. That is, the plurality of point light sources 3a to 3c are arrayed in the direction substantially perpendicular to the outgoing surface 1d of the first light guide body 1. In this manner, it is desirable that at least some of the plurality of point light sources 3a to 3c are arranged in the direction substantially perpendicular to the outgoing surface 1d. As the point light sources, there are LEDs and the like, and ones emitting white light or elements different in color such as RGB are arrayed. Not all the plurality of point light sources 3a to 3c need to be contained in the depressions or holes 1a to 1c, but at least some of them may be contained, and the others may be placed outside the light guide body 1. Moreover, a reflecting sheet 51 may be arranged in a lower surface of the first light guide body 1.

The reflector 4 is arranged between the outgoing surface 1d of the first light guide body 1 and the incident surface 2a of the second light guide body 2, as shown in FIG. 2. A surface of the reflector 4 adjacent to the first and second light guide body is a specular reflecting surface by a mirror surface, or a diffusion/reflecting surface by a white material, and reflectance is desirably 90% or more. As a material of the reflector 4, metal, resin or combination of reflecting materials composed of metal-based resins may be employed.

A display panel that performs display by the light from the above-described surface light source apparatus 10 is arranged on the outgoing surface 2b of the second light guide body 2 in the surface light source apparatus 10 to form a display apparatus.

Although not shown, the display panel and a circuit substrate that drives and controls the display panel are arranged on the outgoing surface 2b of the second light guide body 2, and are irradiated from back surfaces thereof with the irradiating light from the surface light source. Also, a plate made of resin or the like may be arranged instead of the display panel. Moreover, although not shown here, in order to hold and position respective members of the surface light source apparatus 10 and the display apparatus, a case part made of metal or resin may be combined, and further a plurality of case parts may be fitted into one another to be used. In order to improve display performance such as brightness and view angle properties and obtain desired optical properties, one or more optical sheets may be combined on the second light guide body 2.

### (Operation)

Next, the operation of the surface light source apparatus 10 according to the present embodiment is described using the drawings.

As described above, in FIGS. 1 and 2, the light irradiated from the plurality of point light sources 3a to 3c is caused to enter the first light guide body 1 from side surfaces of the depressions or holes 1a to 1c containing the point light sources 3a to 3c, that is, peripheral surfaces of the point light sources 3a to 3c. The incident light from the point light sources is diffused and propagated while repeating total reflection inside the first light guide body 1, so that it spreads uniformly with respect to the illustrated x direction, and is emitted from the outgoing surface 1d.

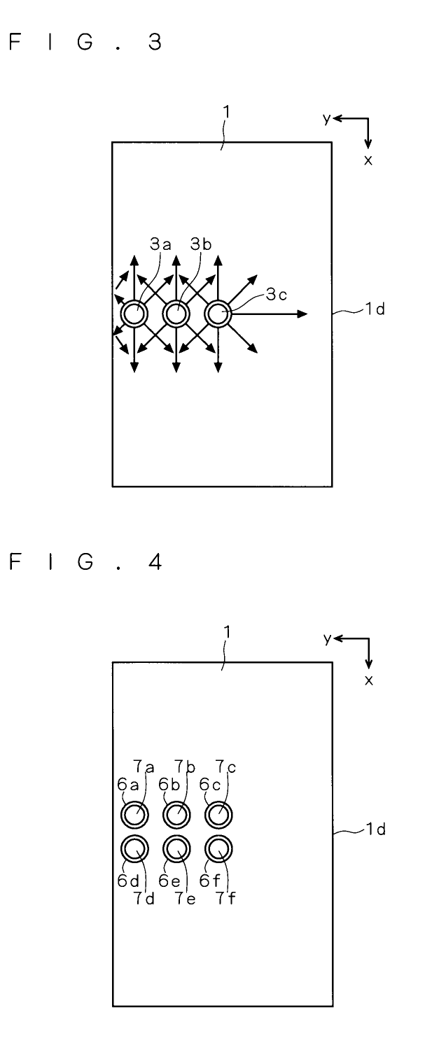

FIG. 3 is a top view of the first light guide body 1, showing positions of the plurality of point light sources 3a to 3c inside the first light guide body 1 and planar spread of the light emitted from the point light sources. As described above, the respective point light sources are arrayed linearly in a y direction shown in the figure, that is, in a direction substantially perpendicular to the outgoing surface 1d, and generally in the center of the first light guide body with respect to the x direction, and with the x direction shown in the figure, the light is propagated inside the first light guide body 1 in a symmetrical spread.

The light emitted from the first light guide body 1 is deflected by the reflector 4 as shown in FIG. 2 to enter the second light guide body 2 from the incident surface 2a thereof. The light entering the second light guide body 2 is scattered by the diffusion means by the fine pattern shape, printing or the like provided in the outgoing surface 2b or the back surface 2c of the second light guide body 2 while being propagated inside the second light guide body 2, and is emitted from the outgoing surface 2b. By adjusting the diffusion means here, a desired intensity distribution of the light emitted from the outgoing surface 2b can be obtained.

### (Effects)

As shown in FIG. 3, by arraying the plurality of point light sources 3a to 3c in the y direction, that is, in the direction substantially perpendicular to the outgoing surface 1d of the first light guide body 1, influence by variations in brightness or chromaticity between the respective point light sources can be eliminated in respective positions in the x direction, which is different from a conventional case where the plurality of point light sources are arrayed in the x direction.

Therefore, even when the plurality of point light sources different in emission color or property such as LEDs consisting of RGB are used, since the respective point light sources are arrayed in the same position in the x direction, the light from the respective light sources is irradiated in an unbiased distribution in the x direction and emitted from the outgoing surface 1d of the first light guide body to enter the second light guide body. Thus, in the incident surface of the second light guide body, irradiation intensity that is not affected by the performance variations between the respective point light sources can be obtained. Therefore, a stable uniform irradiation surface that is not affected by use conditions, lifetime properties and the like even in a case where the plurality of elements different in emission color and property are used as the plurality of point light sources can be obtained.

### Second Embodiment

### (Constitution)

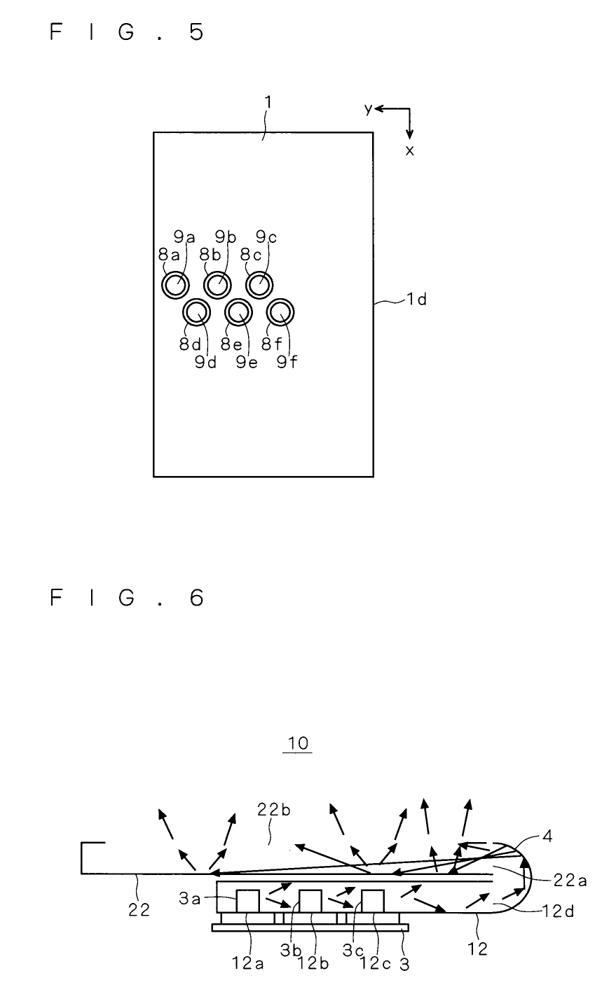

Next, a constitution of a surface light source apparatus according to the present embodiment is described using FIGS. 4 and 5. FIGS. 4 and 5 are top views of the first light guide body 1 installed in the surface light source apparatus according to the present embodiment. The first light guide body 1 is made of a transparent material.

Referring to FIG. 4, the first light guide body 1 includes the outgoing surface 1d from which the light is emitted as in the first embodiment. Moreover, point light sources 7a to 7c are contained in depressions or holes 6a to 6c formed in the first light guide body 1, and are arrayed in the y direction, that is, in the direction substantially perpendicular to the outgoing surface 1d. Similarly, point light sources 7d to 7f are contained in holes 6d to 6f formed in the first light guide body 1, and are arrayed in parallel to a row of the point light sources 7a to 7c, and at equal distances to those of the point light sources 7a to 7c from the outgoing surface 1d.

Referring to FIG. 5, the first light guide body 1 includes the outgoing surface 1d from which the light is emitted as in the first embodiment. Moreover, point light sources 9a to 9c are contained in depressions or holes 8a to 8c formed in the first light guide body 1, and are arrayed in the y direction, that is, in the direction substantially perpendicular to the outgoing surface 1d. Similarly, point light sources 9d to 9f are contained in holes 8d to 8f formed in the first light guide body 1, and are arrayed in parallel to a row of the point light sources 9a to 9c, and at distances closer to the outgoing surface 1d as compared with the point light sources 9a to 9c.

In the surface light source apparatus including the first light guide body 1 shown in FIGS. 4 and 5, since the other constitutions than the first light guide body 1 are similar to those in the first embodiment, detailed descriptions here are omitted.

### (Operation)

In the first light guide body 1 shown in FIG. 4, the light irradiated by the plurality of point light sources 7a to 7f is caused to enter the first light guide body 1 from side surfaces of the depressions or holes 6a to 6f containing the point light sources 7a to 7f, that is, from peripheral surfaces of the point light sources 7a to 7f. In the first light guide body 1 shown in FIG. 5, similarly, the light irradiated by the plurality of point light sources 9a to 9f is caused to enter the first light guide body 1 from side surfaces of the depressions or holes 8a to 8f containing the point light sources 9a to 9f, that is, from peripheral surfaces of the point light sources 9a to 9f.

In both the first light guide body 1 shown in FIG. 4 and the first light guide body 1 shown in FIG. 5, the incident light from the point light sources is diffused and propagated while repeating total reflection inside the first light guide 1, so that it spreads uniformly with respect to the illustrated x direction, and is emitted from the outgoing surface 1d. Since the operation of the light after being emitted from the outgoing surface 1d is similar to that of the first embodiment, a detailed description here is omitted.

### (Effects)

As shown in FIGS. 4 and 5, by arraying the plurality of point light sources in a plurality of rows in the y direction, that is, in the direction substantially perpendicular to the outgoing surface 1d, outgoing light uniform in the x direction can be obtained from the outgoing surface 1d, and as compared with the case where only one row of point light sources are arranged, the outgoing light having higher brightness can be obtained.

For the plurality of point light sources arranged here, a number may be set arbitrarily as needed as a plurality of arrays in both the x and y directions. While the respective rows of the point light sources are desirably arranged in the direction substantially perpendicular to the outgoing surface id, when there is structural limitation, oblique arrangement with respect to the outgoing surface 1d may be employed.

### Third Embodiment

### (Constitution)

Next, a constitution of a surface light source apparatus according to the present embodiment is described using FIGS. 1 and 6.

In the present embodiment, in the surface light source apparatus 10 of FIG. 1 described in the first embodiment, the first light guide body 1 and the second light guide body 2 are made up of a first hollow light guide body 12 (first light guide means) and a second hollow light guide body 22 (second light guide means) each having a reflecting surface in an inner surface of a case having a hollow structure instead of being made of the transparent material. FIG. 6 is a cross-sectional view after assembling.

With the first hollow light guide body 12, the outgoing surface 1d of the first light guide body 1 in FIG. 1 corresponds to an outgoing surface 12d shown in FIG. 6, and the outgoing surface 12d is an opening surface provided in the case. Moreover, holes 12a to 12c for containing the point light sources 3a to 3c as shown in FIG. 6 are formed in similar positions in the x direction and in the y direction to the depressions or holes 1a to 1c in FIG. 1. An inner surface of the first hollow guide body 12 has a mirror surface or a white reflecting surface having high reflectance.

With the second hollow light guide body 22, the incident surface 2a of the second light guide body 2 in FIG. 1 corresponds to an incident surface 22 shown in FIG. 6, and the outgoing surface 2b of the second light guide body 2 in FIG. 1 corresponds to an outgoing surface 22b shown in FIG. 6. Both the incident surface 22a and the outgoing surface 22b are opening surfaces provided in the case. An inner surface of the second hollow light guide body 22 has a mirror surface or a white reflecting surface having high reflectance. As shown in FIG. 6, the first hollow light guide body 12 and the second hollow light guide body 22 are superimposed vertically.

The light source apparatus 3 is installed so that the plurality of point light sources 3a to 3c are contained in the holes 12a to 12c formed in the first hollow light guide body 12, as shown in FIG. 6. More specifically, the plurality of point light sources 3a to 3c are arrayed in the direction substantially perpendicular to the outgoing surface 12d of the first hollow light guide body 12. The reflector 4 is arranged between the outgoing surface 12d of the first hollow light guide body 12 and the incident surface 22a of the second hollow light guide body 22 as shown in FIG. 2. Detailed descriptions of constitutions of the light source apparatus 3 and the reflector 4 are omitted because they are similar to those in the first embodiment.

A display panel that performs display by the light from the surface light source apparatus 10 is arranged on the outgoing surface 22b of the second hollow light guide body 22 in the above-described surface light source apparatus 10 to form a display apparatus.

The point light sources arranged inside the first hollow light guide body 12 may be arranged in a plurality of rows as in the second embodiment, or a constitution may be employed in which either the first or second hollow light guide body is combined with the light guide body made of the transparent material described in the first embodiment. Moreover, instead of the reflector 4, a deflecting element of a transparent material having a prism-shaped cross section may be used.

### (Operation)

Next, the operation of the surface light source apparatus 10 according to the present embodiment is described using FIG. 6. Arrows shown in FIG. 6 illustrate how the light emitted from the point light sources 3a to 3c is propagated.

The light irradiated from the plurality of point light sources 3a to 3c is caused to enter the first hollow light guide body 12. The incident light from the point light sources is propagated inside the case of the first hollow light guide body 12 while spreading, and is emitted from the outgoing surface 12d.

The light emitted from the first hollow light guide body 12 is deflected by the reflector 4 as shown in FIG. 2, and is caused to enter the second hollow light guide body from the incident surface 22a thereof and is emitted from the outgoing surface 22b. Here, by using a mirror surface as the reflector reflecting surface and adjusting its shape, a surface distribution of the light irradiated from the second hollow light guide body can be adjusted.

### (Effects)

By using the light guide bodies each having the hollow structure as the first light guide body and the second light guide body, the surface light source apparatus 10 can be made lighter while ensuring uniform irradiation intensity having no variation in the x direction shown in FIG. 1.

In the first embodiment to third embodiment, the respective point light sources are side by side arranged adjacent to an opposite surface of the outgoing surfaces 1d, 12d. This constitution allows the light emitted from the respective point light sources to be sufficiently mixed in color and emitted from the outgoing surfaces 1d, 12d.

While the invention has been shown and described in detail, the foregoing description is in all aspects illustrative and not restrictive. It is therefore understood that numerous modifications and variations can be devised without departing from the scope of the invention.

What is claimed is:

1. A surface light source apparatus comprising:
a plurality of point light sources;
a first light guide that propagates light received from said plurality of point light sources, and emits the same from an outgoing surface; and
a second light guide that receives the light emitted from said outgoing surface of said first light guide at an incident surface to propagate, and emits the same from an outgoing surface substantially perpendicular to said incident surface,
wherein said plurality of point light sources are arrayed in a direction substantially perpendicular to said outgoing surface of said first light guide, and arrayed substantially in the center with respect to said outgoing surface.

2. The surface light source apparatus according to claim 1, wherein said first light guide and/or said second light guide include a light guide body made of a transparent material.

3. The surface light source apparatus according to claim 1, wherein said first light guide and/or said second light guide include a hollow light guide body having a reflecting surface in an inner surface of a case having a hollow structure.

4. The surface light source apparatus according to claim 1, further comprising a reflector arranged between said outgoing surface of said first light guide and said incident surface of said second light guide.

5. The surface light source apparatus according to claim 1, further comprising a deflecting element arranged between said outgoing surface of said first light guide and said incident surface of said second light guide.

6. The surface light source apparatus according to claim 1, wherein said first light guide is provided with depressions or holes; and
at least some of said plurality of point light sources are contained in said depressions or holes.

7. The surface light source apparatus according to claim 1, wherein said plurality of point light sources include white or red, green and blue LEDs.

8. A display apparatus comprising:
the surface light source apparatus according to claim 1; and
a display panel that are arranged on the outgoing surface of said second light guide in said surface light source apparatus, and performs display by the light from said surface light source apparatus.
